(19) United States
(12) Patent Application Publication
(10) Pub. No.: US 2012/0115424 A1
(43) Pub. Date: May 10, 2012

(54) INSTALLATION TOOL FOR WIRELESS NETWORKS

(75) Inventors: Engel Johannes Knibbe, Heeze (NL); Noël François Leopold Bonne, Zonhoven (BE)

(73) Assignee: KONINKLIJKE PHILIPS ELECTRONICS N.V., EINDHOVEN (NL)

(21) Appl. No.: 13/262,863

(22) PCT Filed: Mar. 30, 2010
(86) PCT No.: PCT/IB2010/051368

§ 371 Date: Jan. 9, 2012

(30) Foreign Application Priority Data
Apr. 6, 2009 (EP) 09157354.3

(51) Int. Cl. H04W 88/18

(52) U.S. Cl. 455/90.1

(57) ABSTRACT

The invention relates to an installation tool for RF (Radio Frequency) networks, such as a wireless networked control system, for example a wireless lighting system. A basic idea of the invention is to provide an installation tool, which allows controlling a setting of a device by performing a simple and intuitive action with the tool, for example turning the tool like a screwdriver. An embodiment of the invention provides an installation tool (10) for a wireless network of devices, wherein the tool comprises
a transceiver (12) to communicate wirelessly information with devices of the wireless network,
an action detector (14) for detecting a user action with the tool, and
a controller (16) configured to control a setting of one or more devices by means of the wireless transceiver upon receipt of an action signal from the action detector.

The invention helps to make the installation of a wireless network, particularly of controlling settings of devices of a wireless network more simple and intuitive for a user by applying the inventive tool than using PDA or computer for installation.

### FIELD OF THE INVENTION

The invention relates to an installation tool for wireless networks, such as a wireless networked control system, for example a wireless lighting system.

### BACKGROUND OF THE INVENTION

A wireless network comprises devices, which are adapted to communicate wireless in the network. In a wireless network, RF (Radio Frequency), optical, or ultrasonic communication technologies may used. Often, RF is applied in wireless networks. A RF network may be for example of a computer network, which comprises several computing devices with RF communication modules, or a networked control system, for example a wireless lighting system with lamps sensors or switches, which comprise RF communication units. Also, coded light technology may be applied for communication in a wireless network.

In a wireless network, all the devices need to be commissioned and configured, in order to realise the right network, and especially in networked control system to create or define a customer required functionality of the system. The commissioning may for example comprise the identifying of the devices, which form network connections, the setting of a security key for a secure communication in the network, the connecting of sensors and actuators with relevant functionality, or the configuring of standard functionality.

These activities can be done by an Installer, or by an Integrator. The Installer is usually preferred for simple smaller systems, because an Integrator is in that case expensive and does not add much value. In many cases the wireless networks are small and, therefore, an Integrator to commission such networks would be too expensive. Also, for small wireless networks, a “plug and play” like approach is preferred for commissioning, since this helps to save time required for the network installation and is more comfortable for an Installer. However, the Installer still must have at least a basic understanding of how the wireless network works, such as addressing schemes or basics of the applied wireless communication technology. Also, the Installer often has to use complex tools to realize the commissioning. Even if, the first network creation sometimes can be done by simply pressing push buttons on the devices only, the configuration of the wireless network often still requires a PDA (Personal Digital Assistant), a computer, or other devices that are in most case unusual to be used by an Installer.

WO2007/123774A2 relates to a wireless service tool for wireless automation systems. The service tool provides a man-machine interface to the building automation system and its components by communicating directly and/or indirectly with the system and its components. The interface displays information about the system and its components.

### SUMMARY OF THE INVENTION

It is an object of the invention to provide an installation tool for a wireless network, which is simple and intuitive to use.

The object is solved by the subject matter of the independent claims. Further embodiments are shown by the dependent claims.

A basic idea of the invention is to provide an installation tool, which allows controlling a setting of a device by performing a simple and intuitive action with the tool, for example turning the tool like a screwdriver. The term “action” as used herein particularly means a movement of the tool such as turning, shaking, waving, or applying a force to the tool such as pressing a certain area on the tool. In general, action means any intuitive user action with the tool. The invention helps to make the installation of a wireless network, particularly of controlling settings of devices of a wireless network more simple and intuitive for a user by applying the inventive tool than using PDA or computer for installation. Also, an Installer is typically more familiar with performing actions like turning a screw driver than with the installing a device with a PDA or computer. Also, the inventive tool may be very helpful for users, which are non proficient with PDAs and computers.

An embodiment of the invention provides an installation tool for a wireless network of devices, wherein the tool comprises
a transceiver to communicate wirelessly information with devices of the wireless network,
an action detector for detecting a user action with the tool, and
a controller configured to control a setting of one or more devices by means of the wireless transceiver upon receipt of an action signal from the action detector. The tool may have a shape for example similar to a screw driver or any other well known tool, which is preferably used by Installers. With this installation tool, an Installer may easily control settings of devices of a wireless network without any comprehensive technical knowledge of the network. A setting of a device herein means for example linking or unlinking of a device to or from a wireless network, or also controlling the behavior of a device in the network. Thus, controlling of a setting of a device with the inventive installation tool has a broad meaning in the context of the invention and comprises in principle every device controlling, which may be performed with devices of a wireless network.

The controller may be configured to control a linking procedure of two devices by means of the wireless transceiver upon receipt of an action signal from the action detector. Linking of two devices for forming a network is a typical installation and in many cases complex task and, therefore, an application, for which the inventive installation tool is ideally suited since it may free Installers from using PDAs and computers and any complex configuration proceedings, since the inventive installation tool automatically performs the linking procedure, and the Installer must only perform some typical and convenient steps like using an installation tool such as screw driver.

The controller may be further configured to perform the following first procedure upon receipt of a first action signal:
receiving a first identifier from a first device located close to the tool by means of the wireless transceiver,
storing the first identifier, and
indicating to the first device that it will be linked to a second device.

The controller may yet be further configured to perform the following second procedure upon receipt of a second action signal:
transmitting the stored first identifier to a second device located close to the tool by means of the wireless transceiver, and
requesting the second device to form a network connection with the first device by using the first identifier.

Both, the first and second procedure may be implemented in a program, which is for example stored in a memory of the tool or the controller and executed by the controller, when an action signal was received.

The controller may be yet further configured
to erase the first identifier after performing the second procedure, and
to perform the first procedure only if no first identifier is stored.

This may avoid that an Installer starts a further linking procedure, while a previous linking procedure is not yet finished. Also, it may avoid that unintentionally a device is linked to another device, for example when an Installer starts a linking procedure, but forgets to finish the procedure, and in the meantime starts another linking procedure.

The controller may also be configured to control an unlinking procedure of a device from a network by means of the wireless transceiver upon receipt of an action signal from the action detector. For example, when a counterclock wise turn of the tool is detected, this may trigger an unlinking of a device from a network similar to unscrewing.

The action detector may comprise one or more of the following:
an angle detector being adapted to detect a rotation of the tool and to signal a detected rotation with an action signal, particularly an angle detection IC or gyroscope;
an accelerometer;
a pressing detector being adapted to detect a pressing of the tool and to signal a detected pressing with an action signal;
a waving detector being adapted to detect a waving of the tool and to signal a detected waving with an action signal;
shaking detector being adapted to detect a shaking of the tool and to signal a detected shaking with an action signal.

The wireless transceiver may be configured to wirelessly communicate by using one or more of the following communication technologies:
RF communication technology;
optical communication technology;
ultrasonic communication technology.

The wireless transceiver may for example comprise a RF unit for radio communication, a photodiode with a LED for optical communication, and/or an ultrasonic transducer for ultrasonic communication.

Furthermore, the tool may comprise means for configuring a setting to be communicated to a device. Thus, a setting may not only be configured by a certain action with the tool, but also for example by traditional input means such as buttons or knobs.

The means for configuring a setting may comprise switching means for configuring the setting and/or display means for displaying a configured setting. The switching means may comprise for example several buttons, with which a desired setting of a device may be manually input by an Installer. The display may make the inputting of the setting more comfortable for the Installer. For example, an Installer may input with the buttons a desired setting, control the input with the display, and then start to communicate the inputted the setting to the device by performing a certain action with the tool, like turning it clock wise such as screwdriver, in order to transmit the setting to the device to be configured.

A further embodiment of the invention relates to an adapter for a tool of the invention and as described above, wherein the adapter is adapted
to store a configuration setting for a device of the wireless network and
to be coupled to the tool so that the tool can read the stored configuration setting.

The adapter may be a head, which is adapted to be attached to the tool so that the stored configuration setting may be read by the tool.

The adapter may be also a memory card or USB stick or any data carrier.

A further embodiment of the invention relates to a method for installing a wireless network of devices with an installation tool of the invention and as described above, the method comprising:
detecting an action with the installation tool and
wirelessly controlling a setting of a device.

A device to be controlled may be selected with the installation tool in that the installation tool uses a focused a laser beam on a optical receiver of the device. This does not require an Installer to manually configure the device for an installation mode and is helpful for device, which are located at places, which can not so easily reached by an Installer.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

FIG. 1 shows a block diagram of an embodiment of an installation tool according to the invention; and

FIG. 2 shows a flowchart of an embodiment of a program executed by a processor of the installation tool according to the invention, in order to perform a linking procedure to be controlled with the installation tool.

### DETAILED DESCRIPTION OF EMBODIMENTS

In the following, functionally similar or identical elements may have the same reference numerals.

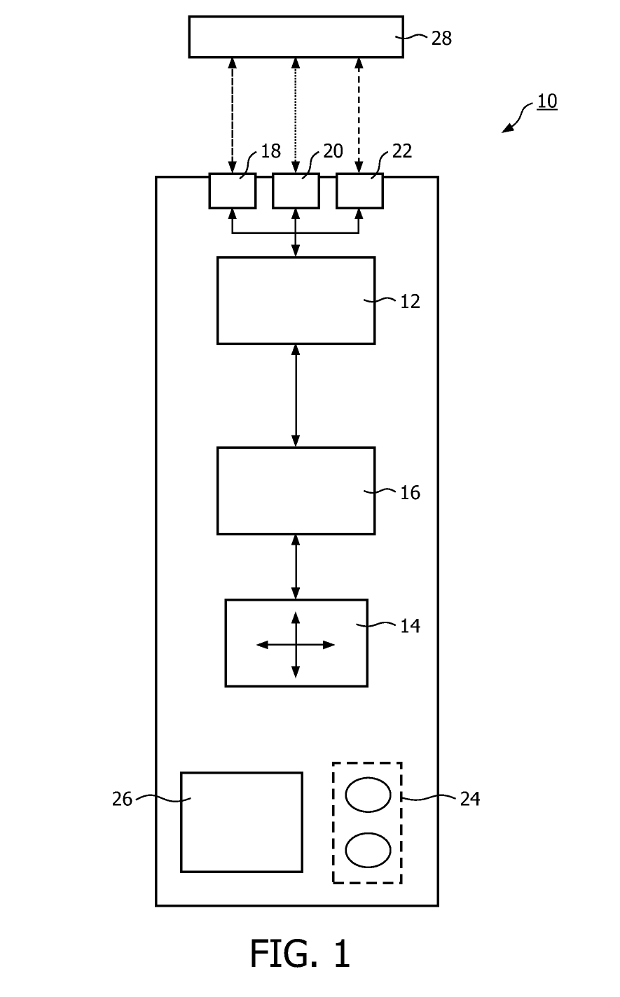

FIG. 1 shows a block diagram of an embodiment of the installation tool 10 according to the invention. The tool 10 is shaped like a screw driver handle with a display 26, for example a LCD display, and buttons 24 for configuring settings of devices to be configured or installed with the tool 10. The central element of the tool 10 is a processor 16, for example implemented with a microcontroller, which controls a transceiver circuit 12. The transceiver circuit 12 is coupled to a RF circuit 18, an optoelectronic circuitry 20, and an ultrasonic transducer 22 and adapted to control these communication means 18, 20 and 22. The tool 10 further comprises an action detection circuit 14 such as an accelerator circuit, which is adapted to detect movements of the tool 10, for example a rotating, a shaking, or a waving of the tool. Particularly, the action detection circuit 14 is adapted to detect a clockwise or anticlockwise rotating of the tool 10 such as it is performed with a screwdriver. Any action, which is detected by the action detection circuit 14, is signaled to the processor 16, which executes a program to process the signaled detected action. Depending on the processing of the signaled action and further parameters, the processor 16 controls the wireless transmission of information to or reception of information from a device 28, which is to be installed, via the transceiver circuit 12 and the wireless communication means 18, 20, and 22.

In the following, the usage of the tool 10 by an installer for installing a wireless network of devices, for example a wireless lighting devices network, is explained. It should be noted that the tool 10 may be used not only for installation of a wireless network as described in the following, but to perform any installation of devices of a wireless network, also for example the configuration of single devices of the network.

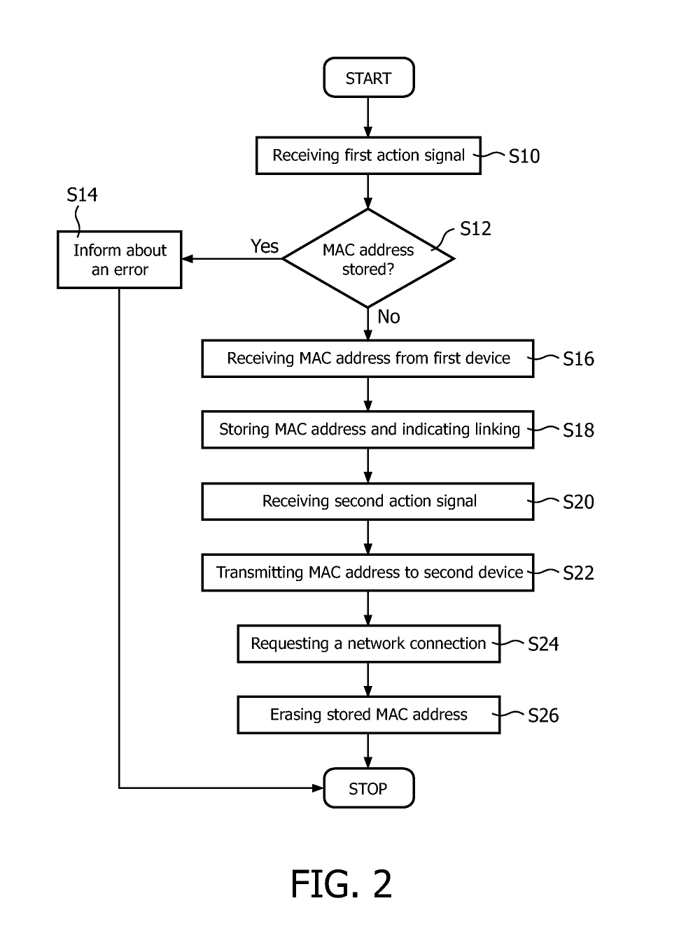

Now, the installation process by using the tool 10 is described with reference to FIG. 2, which shows a flow chart of a program implemented in the tool 10 and executed by the processor 16: The program may be stored in an internal memory of the processor 16, or in a memory (not shown) of the tool 10.

To start creation of a network, the installer simply presses one of the buttons 24 on the tool 10, e.g. alike for voltage measurement, in order to switch the tool 10 on, which may be battery powered. To create the network, the installer uses the tool 10 in that it is placed on or close to a device 28 to be installed and turned clockwise to link the device 28 to the network (or counter-clockwise to unlink it from the network). An alternative is that the tool works from a distance, using an activation/selection signal from the tool towards the device. This could be a narrow beam of light, ultrasonic energy, or RF energy. Or more particular it could be a laser beam that is detected by the device. In this case, an Installer merely has to focus the laser beam send out by the installation tool to an optical receiver of the device to be installed. This method is very helpful for devices, which are installed at locations, which cannot be easily reached by an Installer, for example in the ceiling of a house.

A turn of the tool 10 is detected by the action detection circuit 14 and signaled to the processor 16. Processor 16 executes the mentioned program to process the signal, received in step S10 of the program. The program analyzes the signaled action in order to determine which procedure should be initiated by the tool 10. When the analysis of the action signaled by the action detection circuit 14 results in that the installer turned the tool 10 clockwise, the program executed by the processor 16 starts a procedure for linking the device to another device in order to form a network. The linking procedure comprises a first and a second procedure, which are executed consecutively. However, before executing the first procedure, it is checked in step S12 whether any MAC (Medium Access Control Layer) address of a device of the wireless network is temporarily stored in the internal memory of the processor 16. If a MAC address is already stored, the in step S14 an information that an error during the linking procedure occurred, and the program stops. The Installer can in that case erase the stored MAC address or finishing a procedure, during which the MAC address was stored. If no MAC address is temporarily stored, the first procedure of the linking procedure is executed.

When executing this first procedure, the processor 16 first switches the transceiver circuit 12 into a wireless reception mode. The transceiver circuit 12 then switches the communication means 18, 20 and 22 into the reception mode in order to “listen” to incoming signals from the device 28. The device 28 may be brought into an installation mode by the installer, in which it broadcasts it MAC address and particularly a network ID and/or a security key for a predefined period of for example 30 seconds. This might be done also automatically by the tool itself in that the tool 10 transmits a message to the device 28, requesting it's MAC address and/or network ID and/or security key. In that case the transceiver circuit 12 first transmits the message and then goes into reception mode. Depending on the communication technology used by the device 28, one of the communication means 18, 20 or 22 may receive the broadcast MAC address and/or network ID and/or security key during the predefined broadcasting period (step S16). The MAC address and/or network ID and/or security key received from the device 28 is passed to the transceiver circuit 12, which forwards it to the processor 16. Upon receipt of the MAC address and/or network ID and/or security key, the processor 16 temporarily stores the MAC address and/or network ID and/or security key in an internal memory, and instructs the transceiver to send to the device 28 a message indicating it will be linked to a second device (step S18).

Then, the installer may hold the tool 10 to the second device (not shown, but similar to the shown device 28) and turn the tool 10 again clockwise. This clockwise turn is detected by the action detection circuit 14 and signaled to the processor 16, which executes the second procedure of the linking procedure (step S20). During this second procedure, the processor 16 loads the temporarily stored MAC address of the first device and/or network ID and/or security key from its internal memory and instructs the transceiver circuit 12 to send the MAC address and/or network ID and/or security key to the second device by using the same communication means (step S22), with which the MAC address and/or network ID and/or security key was received from the first device. The processor 16 also instructs the transceiver circuit 14 to send a request for network forming to the second device (S24). The second device may be brought into a linking mode by the installer, during which it may receive commands from the tool 10 for a predefined period of for example 30 seconds. Upon receipt of the MAC address of the first device and/or network ID and/or security key and the network forming request by the second device, the second device will directly communicate with first device by using the received MAC address and/or network ID and/or security key and form a network connection with the first device. After performing the second procedure, the processor 16 erases the MAC address of the first device and/or network ID and/or security key from its internal memory (S26) and may switch the tool 10 back in for example a standby mode, in which any action detected by the action detection circuit 14 may cause the tool 10 to perform a dedicated function.

Instead of erasing the MAC address, the above described installation process can continue identically with the next devices that need to be connected to this network.

Further, when more functions are added, the tool 10 can be used to (read and) set certain functionality in the device 28; and it can be used to readout diagnostic information of the device.

As shown in FIG. 1, the tool may be equipped to communicate with devices using several communication technologies such as RF, optical (for example by means of coded light), and ultrasonic.

The action detection circuit 4 may be adapted not only to detect turns of the tool 10, but also other actions or movement like pressing, waving, etc.

The tool 10 may be also adapted to be switched on with a certain action like a wave, shake, shock, etc.

A setting of a configuration of a device can be implemented in various means. One is that the tool may show various settings on it's handle, which can be turned to the right values, after which a setting can be passed to a device by holding it close and either pressing a store button, doing a full twist, or other variants.

Also the tool could have a magazine of heads, each representing a specific configuration, which can be put on the tool's handle. In this case the configuration can be passed along during the linking process described above.

More complex but having more options as well is integrating a small display and some control buttons on the tool's handle, as shown in FIG. 1 by reference numerals 24 and 26. This allows setting of all configuration items, after which they can again be passed to the devices.

Diagnostics is in principle also possible: using either LEDs on the handle to indicate status and issues, or using a small display.

The invention can be used for the installation of devices of any kind of wireless networks, but is particularly useful for installing devices of wireless networked control system such as wireless lighting systems. The invention is particularly useful for simple RF solutions for offices, hospitality and retail, where limited commissioning is required. Also, it may be helpful for retrofit solutions. For example, the tool could be marketed together with sets of configuration settings for devices of wireless networks, such as for configuration settings for lamps of a complex wireless lighting system. Also, the configuration settings could be sold separately.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. An installation tool for a wireless network of devices, the tool comprising:
a transceiver configured to communicate wirelessly information with devices of the wireless network,
an action detector for detecting a user action and generating at least one action signal in response thereto, and
a controller configured to control a setting of one or more devices by means of the wireless transceiver upon receipt of the action signal from the action detector.

2. The tool of claim 1, wherein the controller is configured to control a linking procedure of two devices by means of the wireless transceiver upon receipt of the at least one action signal from the action detector.

3. The tool of claim 2, wherein the controller is configured to perform the following first procedure upon receipt of a first action signal:
receiving a first identifier from a first device located close to the tool by means of the wireless transceiver,
storing the first identifier, and
indicating to the first device that it will be linked to a second device.

4. The tool of claim 3, wherein the controller is further configured to perform the following second procedure upon receipt of a second action signal:
transmitting the stored first identifier to a second device located close to the tool by means of the wireless transceiver, and
requesting the second device to form a network connection with the first device by using the first identifier.

5. The tool of claim 3, wherein the controller is further configured
to erase the first identifier after performing the second procedure, and
to perform the first procedure only if no first identifier is stored.

6. The tool of claim 1, wherein the controller is configured to control an unlinking procedure of a device from a network by means of the wireless transceiver upon receipt of an action signal from the action detector.

7. The tool of claim 1, wherein the action detector comprises one or more of the following:
an angle detector being adapted to detect a rotation of the tool and to signal a detected rotation with an action signal, particularly an angle detection IC or gyroscope;
an accelerometer;
a pressing detector being adapted to detect a pressing of the tool and to signal a detected pressing with an action signal;
a waving detector being adapted to detect a waving of the tool and to signal a detected waving with an action signal;
shaking detector being adapted to detect a shaking of the tool and to signal a detected shaking with an action signal.

8. The tool of claim 1 wherein the wireless transceiver is configured to wirelessly communicate by using one or more of the following communication technologies:
RF communication technology;
optical communication technology;
ultrasonic communication technology.

9. The tool of claim 1 further comprising means for configuring a setting to be communicated to a device.

10. The tool of claim 9, wherein the means for configuring a setting comprise switching means for configuring the setting and/or display means for displaying a configured setting.

11-14. (canceled)
